(19) United States
(12) Patent Application Publication
(10) Pub. No.: US 2017/0094249 A1
(43) Pub. Date: Mar. 30, 2017

(54) OPTICS ARCHITECTURE FOR 3-D IMAGE RECONSTRUCTION

(71) Applicant: QUALCOMM Incorporated, San Diego, CA (US)

(72) Inventors: Jacek MAITAN, Mountain View, CA (US); Ying ZHOU, Cupertino, CA (US); Russell GRUHLKE, Milpitas, CA (US)

(21) Appl. No.: 14/864,761

(22) Filed: Sep. 24, 2015

(51) Int. Cl. H04N 13/02; G02B 17/08; H04N 5/225

(52) U.S. Cl. CPC H04N 13/0203; H04N 13/0271; H04N 5/2254; H04N 5/2257; G02B 17/08

(57) ABSTRACT

Methods, systems, computer-readable media, and apparatuses for reconstructing a three-dimensional (3D) image are presented. In some implementations, the method collects rays emanating from a source or object and focuses the rays emanating from the source or object towards a first reflecting element. The method then focuses the rays emanating from the source or object towards a second reflecting element. The method then redirects the focused rays from the first lensing element toward a second reflecting element. The method then redirects the focused rays from the second lensing element toward a fourth reflecting element. The method then reconstructs a 3D image representing the source or object based at least in part on rays impinged upon the image sensor of the imaging device.

### BACKGROUND

Aspects of the disclosure relate to computer vision. Computer vision is a field that includes methods for acquiring, processing, analyzing, and understanding images for use in applications. Traditionally, a processor coupled to a sensor, acquires image data from a sensor and performs certain computer vision (CV) operations on the information received from sensor for detecting features and consequently objects associated with those features. Features may include features such as edges, corners, etc. In some instances, features may also include more complex human features, such as faces, smiles and gestures. Programs executing on the processor may utilize the detected features in a variety of applications, such as plane-detection, face-detection, smile detection, gesture detection, etc.

Much effort has been made in recent years to enable computing devices to detect features and objects in the field of view of the computing device. Computing devices, such as mobile devices, are designed with sensitivity towards the amount of processing resources and power used by the mobile device and heat dissipation. However, traditionally, detecting features and objects in the field of view of the computing device, using a camera, requires significant processing resources resulting in higher power consumption and lower battery life in computing devices, such as mobile devices.

The use of a depth map to perform CV operations has become increasingly popular. A depth map is an image that contains information relating to the distance of the surfaces of scene objects from a viewpoint. The distance information obtainable from a depth map can be used to implement the CV features described above. However, computing a depth map is a very power-intensive operation. For example, a frame based system must inspect pixels in order to retrieve links for pixels used in processing of a 3-D map. In another example, all the pixels must be illuminated in order to capture a time-of-flight measurement. Both the implementations of the illustrated examples are power intensive. Some solutions attempt to use a low power activity event representation camera in order to conserve power usage. However, low power activity event representation cameras are noisy, resulting in computation problems in finding a good match between points.

Thus, a need for a low power depth map reconstruction architecture exists.

### BRIEF SUMMARY

Certain implementations are described that implement a low-power event-driven activity event representation camera (AER). The low-power event-driven AER can bypass known limitations corresponding to AERs by (1) using a single camera with a single focal plane; (2) using a visualization pyramid processing scheme described formally in terms of attributes grammars leading to synthesizable electronics; and (3) using focal plane electronics to correlate events along the same horizontal line, eliminating the known noise problem due to image reconstruction of the focal plane; (4) using focal plane electronics to remove events too far away (e.g., z-axis) by thresholding events that are too far away, reducing the processing and making it appropriate for a mobile device application; (5) proposing optical path modifications to enable the use of inexpensive high aperture (f) lenses to handle high-speed action; and (6) using optics with two optical paths folding the image.

In some implementations, an imaging device includes a first and second lensing element to collect and focus rays emanating from a source or object, wherein the first and second lensing element are each mounted to a surface of the imaging device and are separated by a particular length or distance along an external surface of the imaging device. The imaging device also includes a first reflecting element to collect and redirect rays from the first lensing element to a second reflecting element of the imaging device, wherein the first reflecting element and the second reflecting element are each mounted to a particular internal surface of the imaging device. The imaging device further includes a third reflecting element to collect and redirect rays from the second lensing element to a fourth reflecting element of the imaging device, wherein the third reflecting element and the fourth reflecting element are each mounted to a particular internal surface of the imaging device. In some implementations, the rays reflected by the second reflecting element and the fourth reflecting element each impinge upon an image sensor of the imaging device for three-dimensional (3D) image reconstruction of the source or object, and wherein the optical path length between the first lensing element and the image sensor is equal to the optical path length between the second lensing element and the image sensor.

In some implementations, a length of the optical path between the first lensing element and the first reflecting element is different than a length of the optical path between the first reflecting element and the second reflecting element.

In some implementations, the length of the optical path between the first lensing element and the first reflecting element is greater than the length of the optical path between the first reflecting element and the second reflecting element.

In some implementations, the length of the optical path between the first lensing element and the first reflecting element is less than the length of the optical path between the first reflecting element and the second reflecting element.

In some implementations, the image sensor is a first image sensor and the imaging device further comprises a third and fourth lensing element to collect and focus rays emanating from the source or object, wherein the third and fourth lensing element are each mounted to a surface of the imaging device and are separated by a particular length or distance along an external surface of the imaging device, a fifth reflecting element to collect and redirect rays from the third lensing element to a sixth reflecting element of the imaging device, wherein the fifth reflecting element and the sixth reflecting element are each mounted to a particular internal surface of the imaging device, and a seventh reflecting element to collect and redirect rays from the fourth lensing element to an eighth reflecting element of the imaging device, wherein the seventh reflecting element and the eighth reflecting element are each mounted to a particular internal surface of the imaging device. In some implementations, rays reflected by the sixth reflecting element and the eighth reflecting element each impinge upon the second image sensor of the imaging device for 3D image reconstruction of the source or object.

In some implementations, a distance between the first and second lensing element is equal to a distance between the third and fourth lensing element.

In some implementations, the reconstruction of the source object comprises reconstructing the source object based at least in part on a combination of the impinging upon the first image sensor and the impinging upon the second image sensor.

In some implementations, the imaging device is built into a mobile device and is used for an application-based computer vision (CV) operation.

In some implementations, a method for reconstructing a three-dimensional (3D) image comprises collecting, via a first and second lensing element, rays emanating from a source or object, wherein the first and second lensing element are each mounted to a surface of an imaging device and are separated by a particular length or distance along an external surface of the imaging device. The method also includes focusing, via the first lensing element, the rays emanating from the source or object towards a first reflecting element. The method further includes focusing, via the second lensing element, the rays emanating from the source or object towards a second reflecting element. The method additionally includes redirecting, via the first reflecting element, the focused rays from the first lensing element toward a second reflecting element, wherein the first reflecting element and the second reflecting element are each mounted to a particular internal surface of the imaging device, and wherein the rays impinge, via the second reflecting element, upon an image sensor of the imaging device. The method also includes redirecting, via a third reflecting element, the focused rays from the second lensing element toward a fourth reflecting element, wherein the third reflecting element and the fourth reflecting element are each mounted to a particular internal surface of the imaging device, and wherein the redirected rays impinge, via the fourth reflecting element, upon the image sensor of the imaging device. The method further includes reconstructing a 3D image representing the source or object based at least in part on the rays impinged, via the second reflecting element and the fourth reflecting element, upon the image sensor of the imaging device.

In some implementations, an apparatus for reconstructing a three-dimensional (3D) image includes means for collecting, via a first and second lensing element, rays emanating from a source or object, wherein the first and second lensing element are each mounted to a surface of an imaging device and are separated by a particular length or distance along an external surface of the imaging device. The method also includes means for focusing, via the first lensing element, the rays emanating from the source or object towards a first reflecting element. The method further includes, means for focusing, via the second lensing element, the rays emanating from the source or object towards a second reflecting element. The method additionally includes means for redirecting, via the first reflecting element, the focused rays from the first lensing element toward a second reflecting element, wherein the first reflecting element and the second reflecting element are each mounted to a particular internal surface of the imaging device, and wherein the rays impinge, via the second reflecting element, upon an image sensor of the imaging device. The method further includes, means for redirecting, via a third reflecting element, the focused rays from the second lensing element toward a fourth reflecting element, wherein the third reflecting element and the fourth reflecting element are each mounted to a particular internal surface of the imaging device, and wherein the redirected rays impinge, via the fourth reflecting element, upon the image sensor of the imaging device. The method also includes, means for reconstructing a 3D image representing the source or object based at least in part on the rays impinged, via the second reflecting element and the fourth reflecting element, upon the image sensor of the imaging device.

In some implementations, one or more non-transitory computer-readable media storing computer-executable instructions for reconstructing a three-dimensional (3D) image that, when executed, cause one or more computing devices to collect, via a first and second lensing element, rays emanating from a source or object, wherein the first and second lensing element are each mounted to a surface of an imaging device and are separated by a particular length or distance along an external surface of the imaging device. The instructions, when executed, further cause the one or more computing devices to focus, via the first lensing element, the rays emanating from the source or object towards a first reflecting element. The instructions, when executed, further cause the one or more computing devices to focus, via the second lensing element, the rays emanating from the source or object towards a second reflecting element. The instructions, when executed, further cause the one or more computing devices toredirect, via the first reflecting element, the focused rays from the first lensing element toward a second reflecting element, wherein the first reflecting element and the second reflecting element are each mounted to a particular internal surface of the imaging device, and wherein the rays impinge, via the second reflecting element, upon an image sensor of the imaging device. The instructions, when executed, further cause the one or more computing devices to redirect, via a third reflecting element, the focused rays from the second lensing element toward a fourth reflecting element, wherein the third reflecting element and the fourth reflecting element are each mounted to a particular internal surface of the imaging device, and wherein the redirected rays impinge, via the fourth reflecting element, upon the image sensor of the imaging device. The instructions, when executed, further cause the one or more computing devices to reconstruct a 3D image representing the source or object based at least in part on the rays impinged, via the second reflecting element and the fourth reflecting element, upon the image sensor of the imaging device.

The foregoing has outlined rather broadly features and technical advantages of examples in order that the detailed description that follows can be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

Aspects of the disclosure are illustrated by way of example. In the accompanying figures, like reference numbers indicate similar elements, and ***.

FIG. 1 illustrates an example sensor comprising a plurality of sensor elements arranged in a 2-dimensional array, according to some implementations;

FIG. 2A illustrates an example pixel with a sensor element and in-pixel circuitry, according to some implementations;

FIG. 2B illustrates an example peripheral circuitry coupled to the sensor element array, according to some implementations;

FIG. 3 illustrates dedicated CV computation hardware, according to some implementations;

FIG. 4 illustrates an example implementation for a sensing apparatus comprising light sensors, according to some implementations;

FIG. 5 illustrates digitizing a sensor reading, according to some implementations;

FIG. 6 illustrates a technology baseline or protocol for an event-based camera in the context of AER, according to some implementations;

FIG. 7 illustrates a first example imaging device and a second example imaging device, according to some implementations;

FIG. 8 is a graphical illustration of derivation of depth information, according to some implementations;

FIG. 9 is a chart that illustrates the inverse relationship between disparity and distance to an object, according to some implementations; and

FIG. 10 illustrates an implementation of a mobile device, according to some implementations.

### DETAILED DESCRIPTION

Several illustrative implementations will now be described with respect to the accompanying drawings, which form a part hereof. While particular implementations, in which one or more aspects of the disclosure may be implemented, are described below, other implementations may be used and various modifications may be made without departing from the scope of the disclosure or the spirit of the appended claims.

Implementations of a computer vision based application are described. A mobile device being held by a user may be affected by vibrations from the user's hand and artifacts of light changes within the environment. The computer vision based application may uniquely detect and differentiate objects that are closer to the mobile device, allowing for simplified CV processing resulting in a substantial power savings for the mobile device. Further, due to the power savings, this may allow for an always-on operation. An always-on operation may be beneficial for detecting hand gestures as well as facial tracking and detection, all of which are increasingly popular for gaming and mobile device applications.

Implementations of the computer vision based application may use edges within an image for CV processing, eliminating the need to search for landmark points. Basic algebraic formulas can be implemented directly in silicon, allowing for a low-cost, low-power 3-D mapping method that does not require reconstruction and scanning.

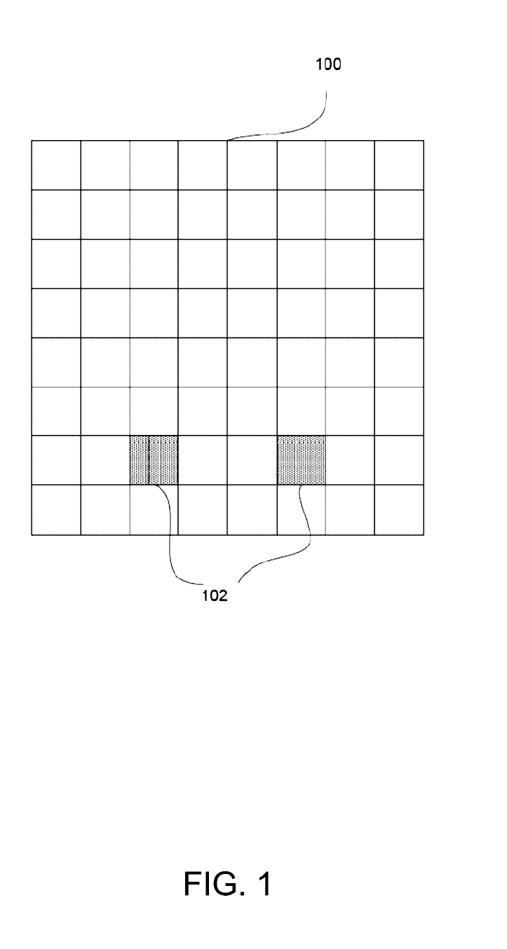

A sensor may include a sensor array of a plurality of sensor elements. The sensor array may be a 2-dimensional array that includes sensor elements arranged in two dimensions, such as columns and rows, of the sensor array. Each of the sensor elements may be capable of generating a sensor reading based on environmental conditions. FIG. 1 illustrates an example sensor 100 comprising a plurality of sensor elements arranged in a 2-dimensional array. In FIG. 1, the illustration of the sensor 100 represents 64 (8×8) sensor elements in the sensor array. In various implementations, the shape of the sensor elements, the number of sensor elements and the spacing between the sensor elements may vastly vary, without departing from the scope of the invention. Sensor elements 102 represents example sensor elements from a grid of 64 elements.

In certain implementations, the sensor elements may have in-pixel circuitry coupled to the sensor element. In some instances, the sensor element and the in-pixel circuitry together may be referred to as a pixel. The processing performed by the in-pixel circuitry coupled to the sensor element may be referred to as in-pixel processing. In some instances, the sensor element array may be referred to as the pixel array, the difference being that the pixel array includes both the sensor elements and the in-pixel circuitry associated with each sensor element. However, for the purposes of the description herein, the terms sensor element and pixel may be used interchangeably.

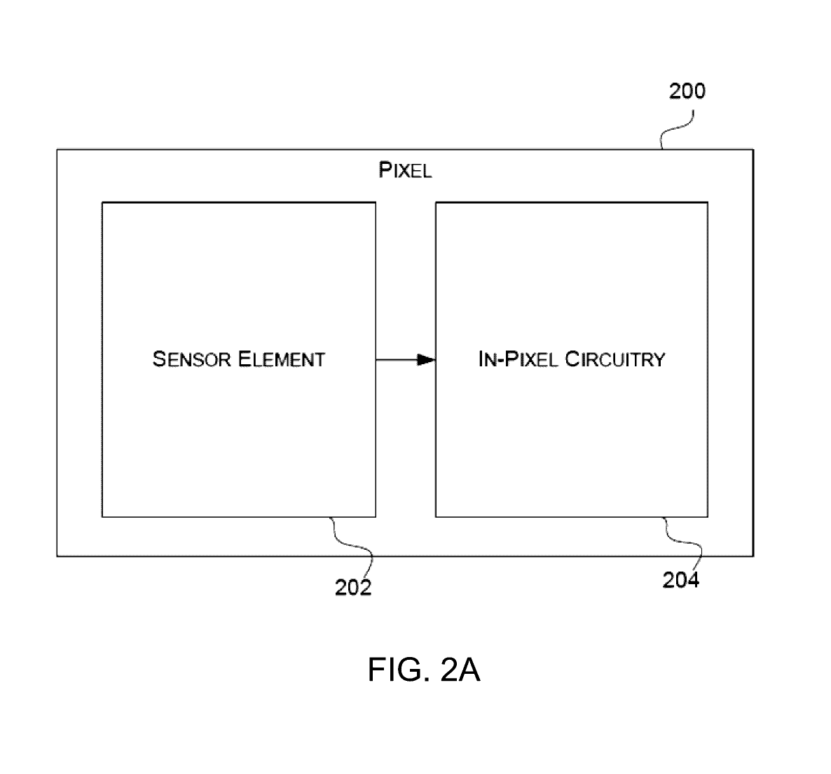

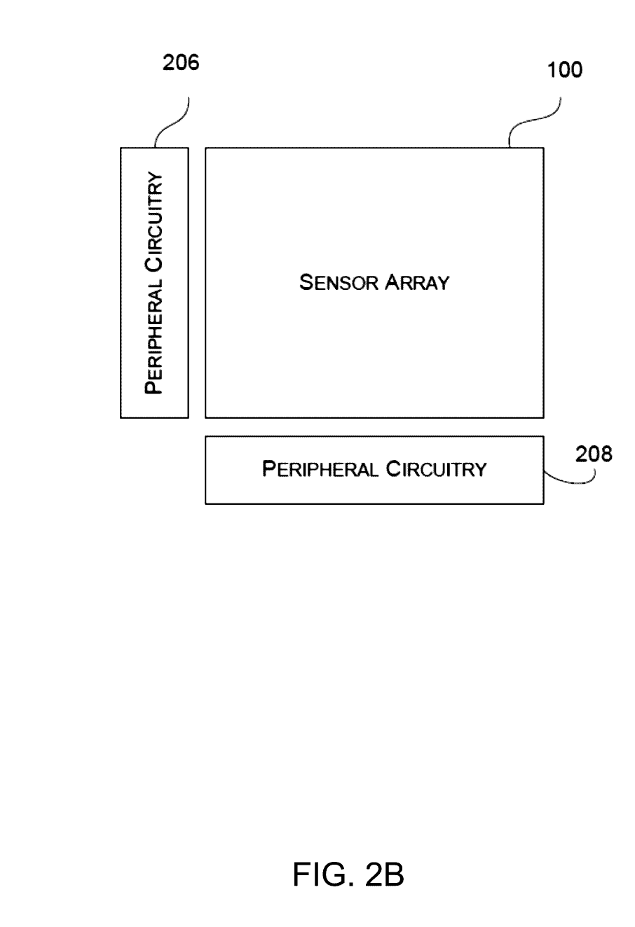

FIG. 2A illustrates an example pixel 200 with a sensor element 202 and in-pixel circuitry 204. In certain implementations, the in-pixel circuitry 204 may be analog circuitry, digital circuitry or any combination thereof.

In certain implementations, the sensor element array may have dedicated CV computation hardware implemented as peripheral circuitry (computation structure) coupled to a group of sensor elements. Such peripheral circuitry may be referred to as on-chip sensor circuitry. FIG. 2B illustrates an example peripheral circuitry (206 and 208) coupled to the sensor element array 100.

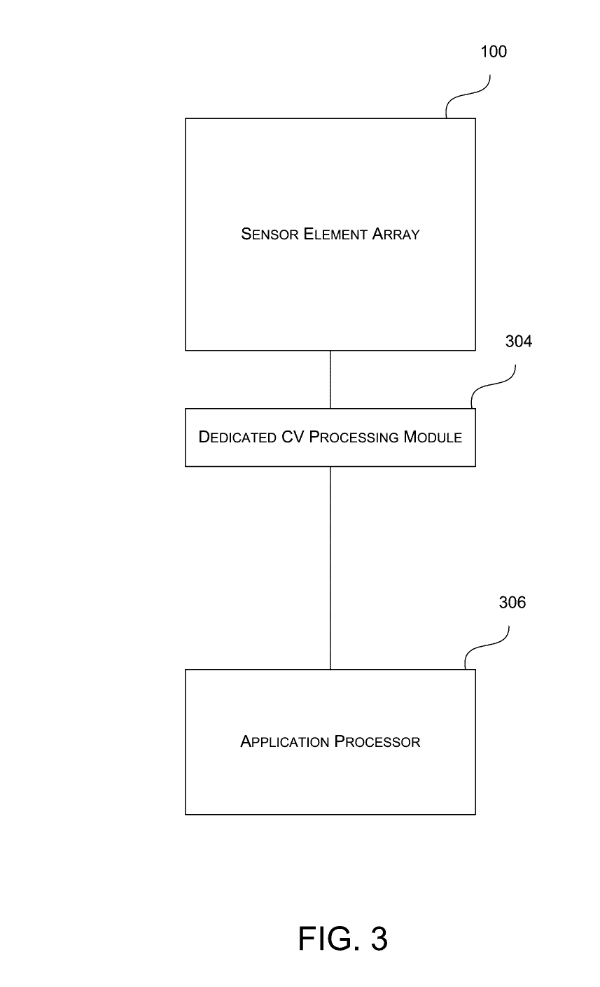

Furthermore, as shown in FIG. 3, in certain implementations, the sensor element array may have dedicated CV computation hardware implemented as dedicated CV processing module 304 coupled to the sensor element array 100 and implemented using an Application Specific Integrated Circuit (ASIC), Field Programmable Gate Array (FPGA), embedded microprocessor, or any similar analog or digital computing logic for performing aspects of the disclosure.

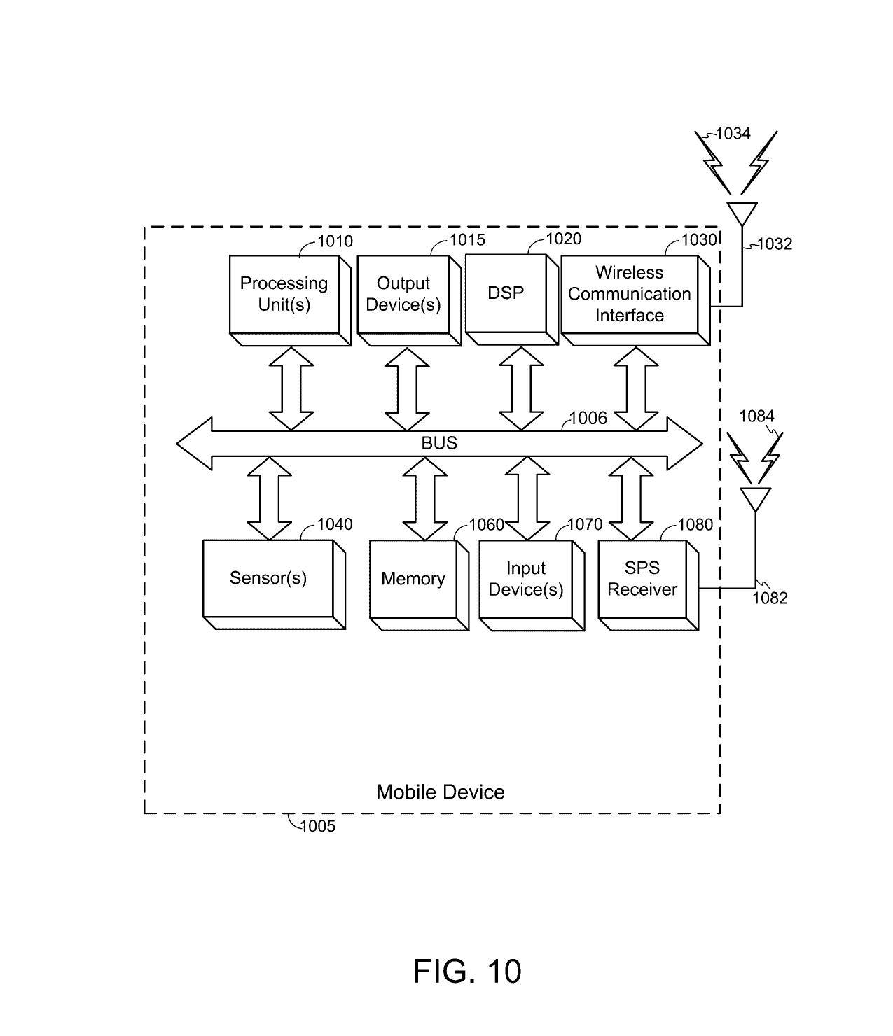

It should be noted, that at least in certain implementations, the dedicated CV processing module 304 may be in addition to an Application Processor 306 and not instead of the Application Processor 306. For example, the dedicated CV processing module 304 may process and/or detect computer vision features. Whereas the Application Processor 306 may receive indications of these detected computer vision features and pattern match against previously stored images or reference indicators to determine macro-features, such as smiles, faces, objects, etc. In addition, the Application Processor 306 may be relatively vastly more complex, compute intensive, power intensive and responsible for executing system level operations, such as operating system, implement the user interface for interacting with the user, perform power management for the device, manage memory and other resources, etc. The Application Processor 306 may be similar to processor(s) 1010 of FIG. 10.

Furthermore, in certain implementations, the sensor array may have peripheral circuitry coupled to a group of sensor elements or the sensor array. In some instances, such peripheral circuitry may be referred to as on-chip sensor circuitry. FIG. 2B illustrates example peripheral circuitry (206 and 208) coupled to the sensor array 100.

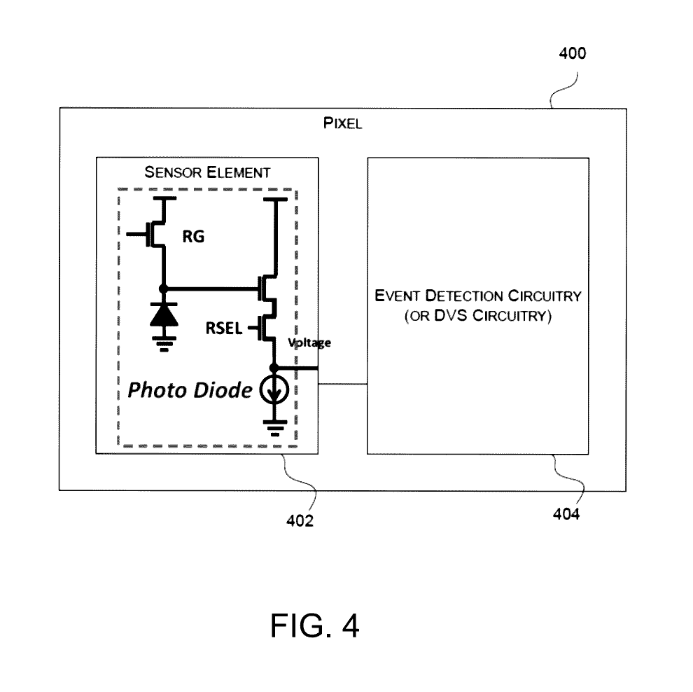

FIG. 4 illustrates an example implementation for a sensing apparatus comprising light sensors. Several techniques may be employed for acquiring an image or a sequence of images, such as a video, using one or more cameras coupled to a computing device.

The example implementation of FIG. 4 illustrates a light sensor using an event-based camera. A light sensor may be used in an image or video camera for acquiring image data. Event based camera sensors may be configured to acquire image information based on an event. In one implementation, the event-based camera may comprise a plurality of pixels, as shown in FIG. 1. Each pixel may comprise a sensory element and in-pixel circuitry. Each pixel 400 may be configured to acquire image data based on an event detected at the pixel. For example, in one implementation, a change in the environmental conditions perceived at any given pixel may result in a voltage change beyond a threshold and may result in an event at the pixel. In response to the event, the logic associated with the pixel may send the sensor element reading to the processor for further processing.

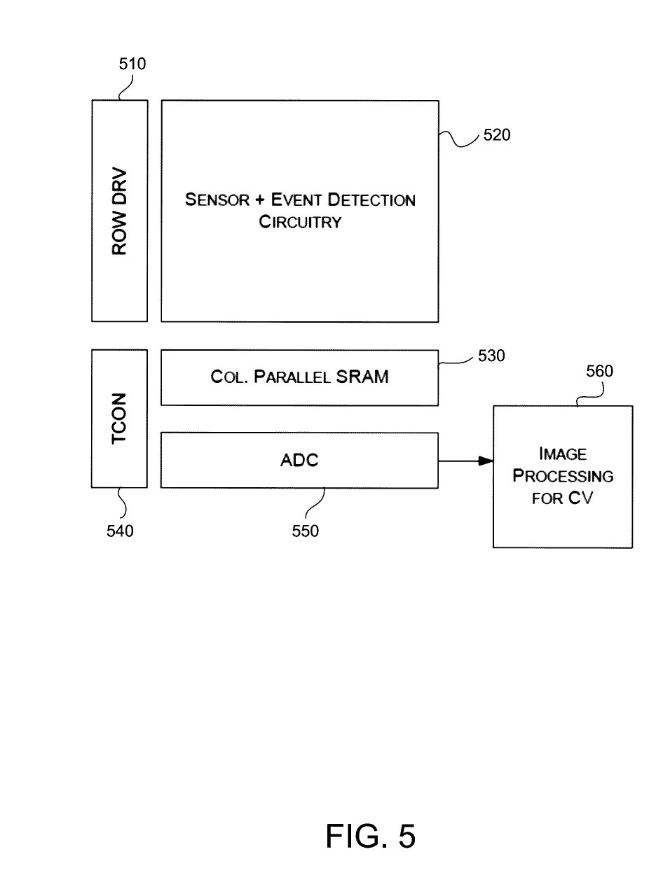

Referring to FIG. 4, each pixel 400 may include a photo diode and dynamic vision sensors (DVS) circuitry 404, as shown in FIG. 4. DVS circuitry 404 may also be referred to as Event detection circuitry. Event detection circuitry detects a change in the environmental conditions and generates an event indicator. If an event is detected, sensor reading is sent out to a processor when the intensity of the pixel changes beyond a threshold. In some instances, the location of the sensor element 402 at which the event was detected along with a payload is sent to a computer system for further processing. In one implementation, the payload may be the intensity voltage, the change in the intensity voltage or the polarity (sign) of the change in the intensity voltage. In some instances, event based cameras may result in a substantially lower amount of data being transferred to a processor for further processing, as compared to traditional frame based cameras, resulting in power savings. Referring to FIG. 5, each pixel generates a sensor reading using the sensor element and digitizes (i.e., converts the data from analog to digital using an ADC converter 550) the sensor reading. In one implementation, the digital result of a previous sensor read may be stored in the Column parallel SRAM 530 for each pixel. The results stored in the Column parallel SRAM 530 may be used by the comparator to compare and trigger an event, based on a comparison between the current sensor reading and a previous sensor reading. The digitized sensor reading may be sent to the processor for further image processing using CV operations 560.

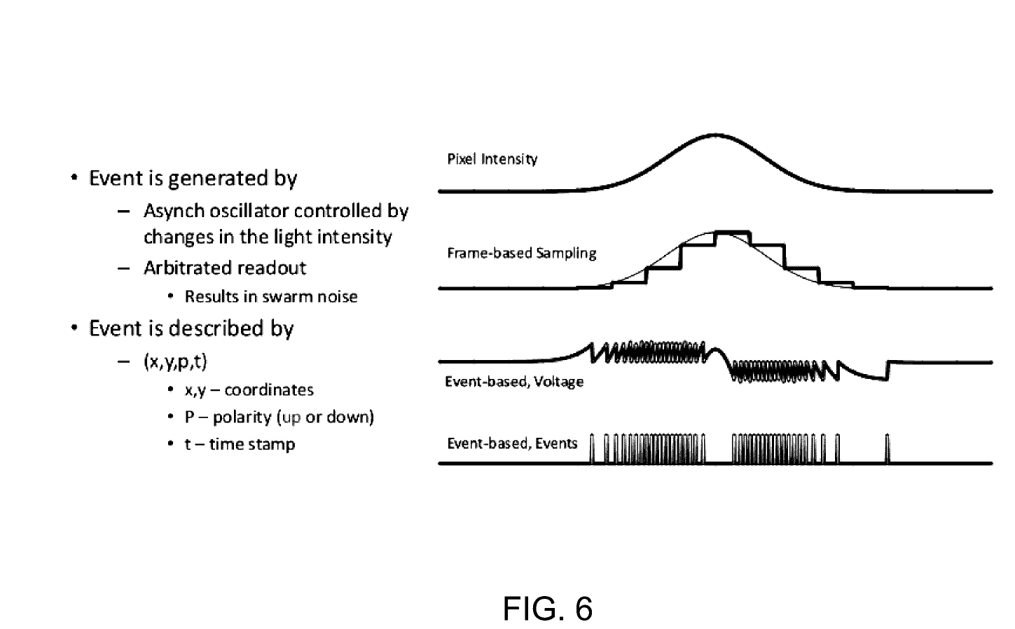

Referring additionally to FIG. 6, a technology baseline or protocol for an event-based camera in the context of AER (Activity Event Representation) is shown. As illustrated, the protocol is event driven where only active pixels transmit their output. A particular event is described by a timestamp t which describes the time when an event has occurred, the coordinates (x,y) which define where the event has occurred in a two-dimensional pixel array, and the polarity p of the contrast change (event) which is encoded as an extra bit and can be ON or OFF (UP or DOWN) representing a fractional change from dark to bright or vice-versa. In general, AER applies asynchronous, concurrent detection of changes in the focal plane to generate edges with minimal power consumption. It is though affected by arbitration noise (due to a global event arbitration scheme that limits the accuracy of depth map reconstruction due to jitter and spatial temporal inefficiencies) and requires relatively high-numbers of events to reconstruct the image. For example, the series of graphs depicted in FIG. 6 show pixel intensity, frame-based sampling, event-based voltage, and event-based events.

Implementations described herein rest upon the idea of increasing AER processing gain in both hardware and software to, among other things, eliminate arbitration noise and reduce I/O by providing information compression though a local arbitration process. More specifically, the thrust of the implementations described herein relate to an optics architecture for on-focal or in-focal plane stereo processing, in order to generate a 3D reconstruction of an object. Further, the use of AER processing can result in lower processing power and lower processing time by giving the location of pixels intensities that crossed a certain threshold.

The current state of global event arbitration schemes are not efficient. AER processing applies asynchronous and concurrent detection of changes in the focal plane to generate edges with minimal power consumption. It is affected by arbitration noise and requires a high-number of events to reconstruct the image. Further, jitter and spatial temporal inefficiencies limit the accuracy of AER based depth maps.

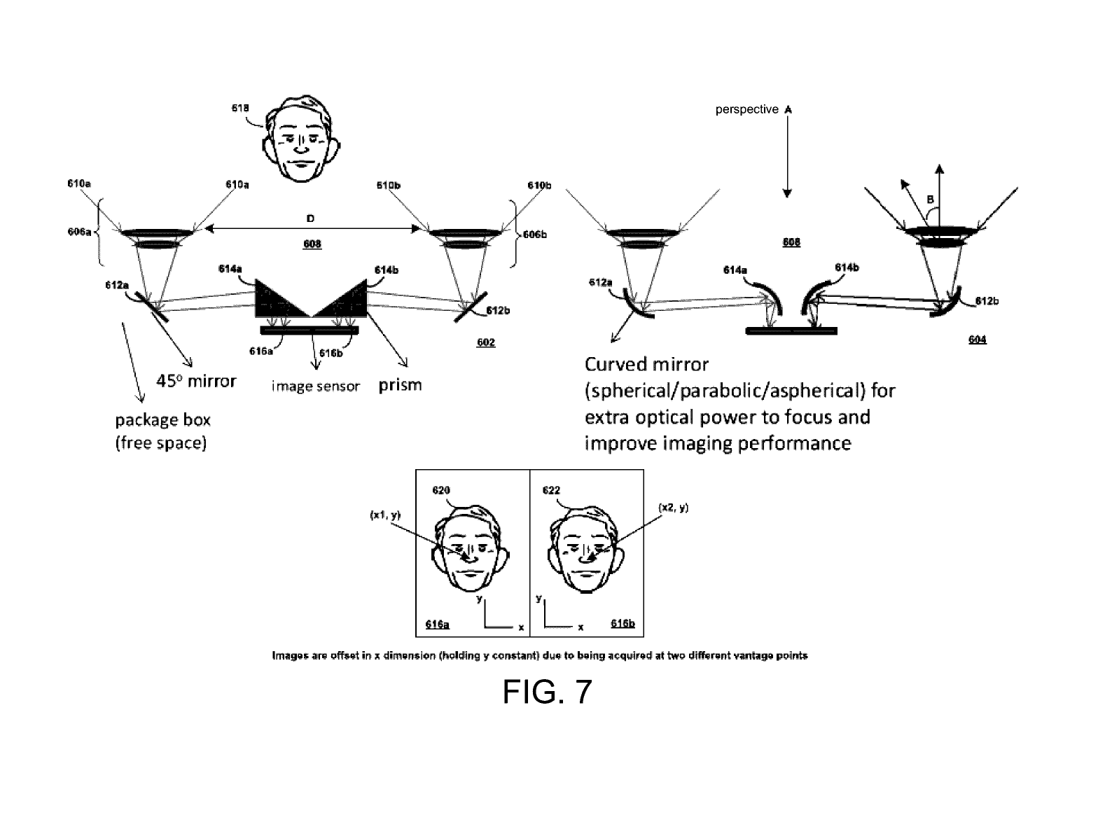

Referring to FIG. 7, a first example imaging device 602 and a second example imaging device 604 are shown in accordance with the disclosure. In practice, lensing elements 606a-b mounted to package 608 (e.g., mobile device or terminal) separated by parallax distance D capture and focus rays 610a-b onto corresponding first reflective elements 612a-b. Since lensing elements 606a-b are separated by distance D, those elements “see” a different field of view and thus enable the parallax stereoscopic or 3D imaging of the disclosure (discussed further below). First reflective elements 612a-b redirect rays 610a-b to corresponding second reflective elements 614a-b, which in turn redirect rays 612a-b onto corresponding image sensor 616a-b. In general, each image sensor 616a-b may be considered a sensor array of a plurality of sensor elements, similar to that described above in connection with FIGS. 1-5. The difference between imaging devices 602, 604 lies in the shape or form of first and second reflective elements 612, 614, whereby upon comparison of the two it may be understood that curved mirrors are utilized instead of planar mirrors/prisms.

The example architectures of FIG. 7 enable the parallax stereoscopic or 3D imaging of the present disclosure by collecting and focusing rays 610a-b emanating/reflecting from a source or object so that the same impinges upon image sensors 616a-b at particular locations—which may be considered course “spots” on image sensors 616a-b. For example, consider the scenario in which the source or object is face 618 as shown in FIG. 6. In this example, rays 610a impinge upon image sensor 616a to form first spot 620, and rays 610b impinge upon image sensor 616b to form second spot 622. By comparing coordinate values (x,y) of particular features of spots 620, 622, relative depth information may be derived, in the form of disparities, and then a 3D reconstruction of face 618 may be obtained. For example, with reference to first spot 620 assume the tip of the nose of face 618 is determined to be at position (x1, y), and with reference to second spot 622 assume the tip of the nose of face 618 is determined to be at position (x2, y). In this example, the delta or difference [x1−x2] may be leveraged to derive relative depth information associated with the tip of the nose of face 618, and in turn this process may be performed at a particular granularity to obtain a 3D reconstruction of face 618 (i.e., relative depth information may be obtained for a large number features of face 618 that which may be used to reconstruct same).

As mentioned above, by comparing coordinate values (x,y) of particular features of spots 620, 622, relative depth information may be derived, in the form of disparities, and then a 3D reconstruction of face 618 (for example) may be obtained.

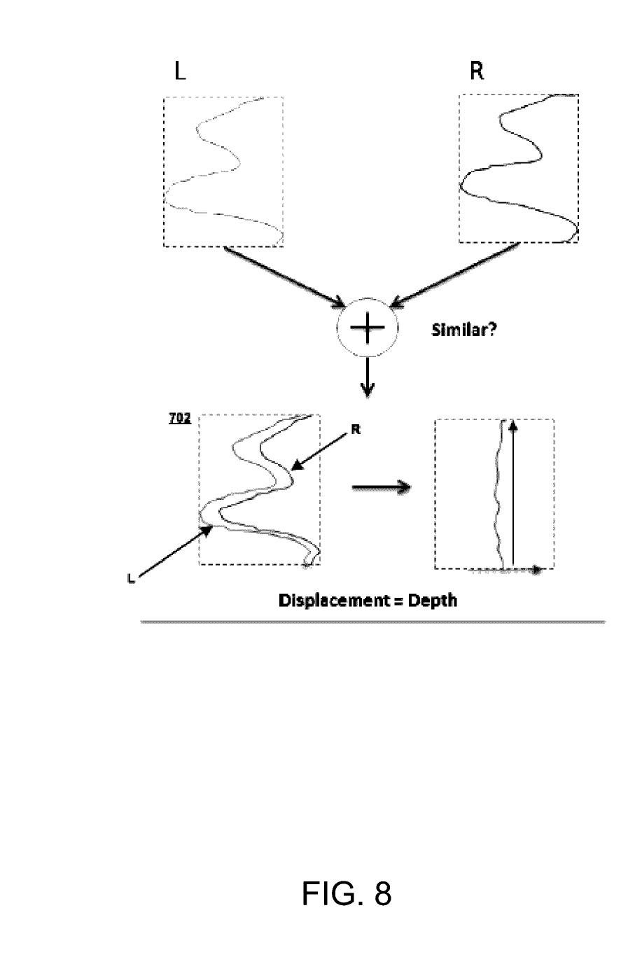

The derivation of depth information is shown graphically in FIG. 8 in chart 702. The algorithm for obtaining the depth map can be described in shorthand terms: Δ(similarity, continuity)=Δ(polygon)=Depth Map. The polygons may be enabled when a change occurs in the focal plane. In essence, the algorithm functions by matching the size of all polygons, computing the depth map, transferring data to the co-processor, and disabling polygons.

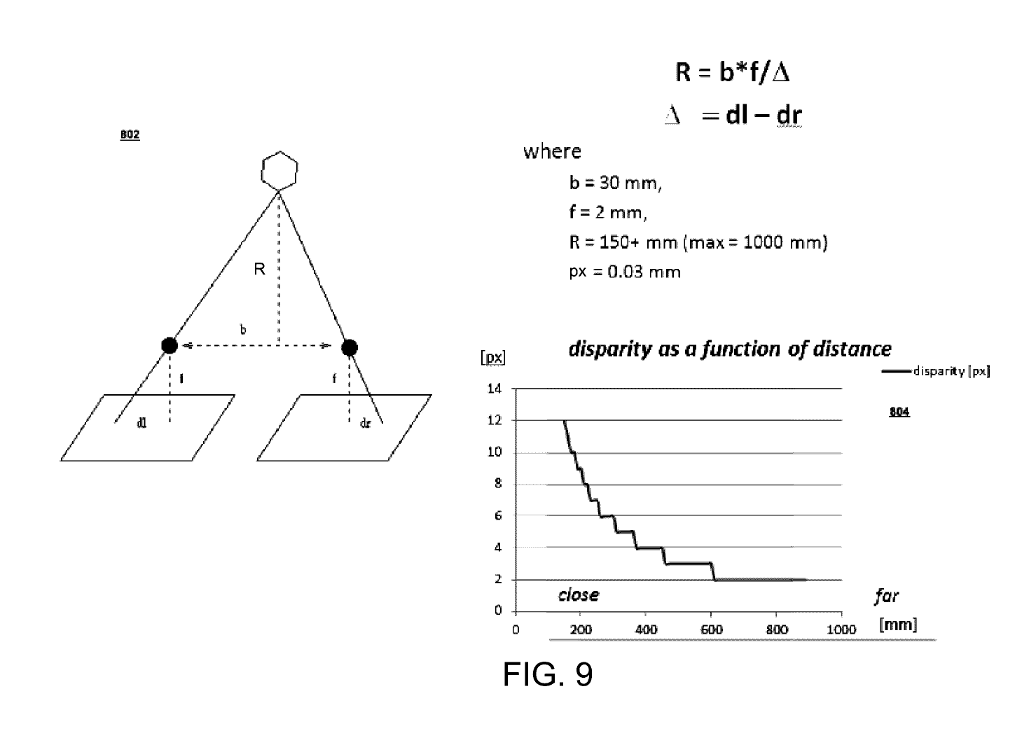

A mathematical difference between two (spatial) signals may be leveraged to quantify depth, and is shown in FIG. 9, whereby geometric model 802 may be leveraged to derive relative depth information. The mathematical relation as applied to the geometrical model 802 can be expressed as:

$$R = b * \frac{f}{Δ}$$

$$Δ = dl + dr$$

where b=distance between lensing elements; f=focal length, dl=distance from object to first lensing element, and dr=distance from object to second lensing element. Some example values for the geometrical model 802 can be where b=30 mm, b=2 mm, 150 mm≧R≦1000 mm, and px=0.03 mm (where px is the disparity). Also shown in FIG. 9 is chart 804 that illustrates the inverse relationship between disparity and distance to an object. As can be seen by chart 804, the disparity decreases as the distance to the object increases.

Also as mentioned above, the thrust of the invention relates to an optics architecture for on-focal or in-focal plane stereo processing. It is contemplated that the geometry and components or materials of the imaging devices 602, 604 may be designed/selected so as to achieve optimal and increasingly accurate parallax stereoscopic or 3D imaging. For example, lensing elements 606a-b may be configured and/or arranged to rotate off-axis (e.g., through angle B as shown in FIG. 7), on-command, to achieve optimal field of view. Additionally, as shown in FIG. 7, two lensing elements 606a-b are shown. When imaging devices 602, 604 are viewed from perspective A (see FIG. 7) lensing elements 606a-b may be considered to be positioned at “12” and “6” on a clock face. It is contemplated that an additional set of lensing elements 606c-d (not shown) may be positioned at “3” and “9” on a clock face so that lensing elements 606a-d are mounted to imaging devices 602, 604 offset 90 degrees (arc) from one another. In this example, additional image sensors and reflective elements may be incorporated into imaging devices 602, 604 to achieve optimal and increasingly accurate parallax stereoscopic or 3D imaging. Further, it can be appreciated that the use of more than two (e.g., multiples of two) imaging elements can be used (e.g., four image sensors including corresponding reflective elements, lensing elements, etc.). In other words, there may be 2*N imaging elements wherein N is a positive integer.

It can be appreciated that by the virtue of the light propagating horizontally within the device, a planar format is achieved. This can be advantageous in devices where thinness is desirable (e.g., mobile devices and smartphones). Since mobile devices are meant to be easily transported by a user, they typically do not have much depth but have a decent amount of horizontal area. By using 2*N imaging elements, the planar format can be fit within a thin mobile device. The stereoscopic nature of the implementations described herein allow for depth determination and a wider field of view from the camera's viewpoint. Example dimensions of such an embedded system in a mobile device include, but are not limited to, 100×50×5 mm, 100×50×1 mm, 10×10×5 mm, and 10×10×1 mm.

FIG. 10 illustrates an implementation of a mobile device 1005, which can utilize the sensor system as described above. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations.

The mobile device 1005 is shown comprising hardware elements that can be electrically coupled via a bus 1006 (or may otherwise be in communication, as appropriate). The hardware elements may include a processing unit(s) 1010 which can include without limitation one or more general-purpose processors, one or more special-purpose processors (such as digital signal processing (DSP) chips, graphics acceleration processors, application specific integrated circuits (ASICs), and/or the like), and/or other processing structure or means. As shown in FIG. 10, some implementations may have a separate DSP 1020, depending on desired functionality. The mobile device 1005 also can include one or more input devices 1070, which can include without limitation a touch screen, a touch pad, microphone, button(s), dial(s), switch(es), and/or the like; and one or more output devices 1015, which can include without limitation a display, light emitting diode (LED), speakers, and/or the like.

The mobile device 1005 might also include a wireless communication interface 1030, which can include without limitation a modem, a network card, an infrared communication device, a wireless communication device, and/or a chipset (such as a Bluetooth™ device, an IEEE 302.11 device, an IEEE 302.15.4 device, a WiFi device, a WiMax device, cellular communication facilities, etc.), and/or the like. The wireless communication interface 1030 may permit data to be exchanged with a network, wireless access points, other computer systems, and/or any other electronic devices described herein. The communication can be carried out via one or more wireless communication antenna(s) 1032 that send and/or receive wireless signals 1034.

Depending on desired functionality, the wireless communication interface 1030 can include separate transceivers to communicate with base transceiver stations (e.g., base stations of a cellular network) access point(s). These different data networks can include various network types. Additionally, a WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE, LTE Advanced, and so on. LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. A WLAN may also be an IEEE 802.11x network, and a WPAN may be a Bluetooth network, an IEEE 802.15x, or some other type of network. The techniques described herein may also be used for any combination of WWAN, WLAN and/or WPAN.

The mobile device 1005 can further include sensor(s) 1040. Such sensors can include, without limitation, one or more accelerometer(s), gyroscope(s), camera(s), magnetometer(s), altimeter(s), microphone(s), proximity sensor(s), light sensor(s), and the like. Additionally or alternatively, the sensor(s) 1040 may include one or more components as described in FIGS. 1-5. For example, the sensor(s) 1040 can include sensor array 100, and the scanning array 100 can be connected to peripheral circuitry 206-208, as described elsewhere in this disclosure. The application processor 306 of FIG. 3 can include a microprocessor dedicated to the sensor system shown in FIG. 3, and this microprocessor may send events to the processing unit(s) 1010 of the mobile device 1005.

Implementations of the mobile device may also include an SPS receiver 1080 capable of receiving signals 1084 from one or more SPS satellites using an SPS antenna 1082. Such positioning can be utilized to complement and/or incorporate the techniques described herein. The SPS receiver 1080 can extract a position of the mobile device, using conventional techniques, from SPS SVs of an SPS system, such as GNSS (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 1080 can be used various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile device 1005 may further include and/or be in communication with a memory 1060. The memory 1060 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 1060 of the mobile device 1005 also can comprise software elements (not shown), including an operating system, device drivers, executable libraries, and/or other code, such as one or more application programs, which may comprise computer programs provided by various implementations, and/or may be designed to implement methods, and/or configure systems, provided by other implementations, as described herein. In an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In implementations provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various implementations may omit, substitute, or add various procedures or components as appropriate. For instance, features described with respect to certain implementations may be combined in various other implementations. Different aspects and elements of the implementations may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several implementations, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

What is claimed is:

1. An imaging device for reconstructing a three-dimensional (3D) image, comprising:
a first and second lensing element to collect and focus rays emanating from a source or object, wherein the first and second lensing element are each mounted to a surface of the imaging device and are separated by a particular length or distance along an external surface of the imaging device;
a first reflecting element to collect and redirect rays from the first lensing element to a second reflecting element of the imaging device, wherein the first reflecting element and the second reflecting element are each mounted to a particular internal surface of the imaging device; and
a third reflecting element to collect and redirect rays from the second lensing element to a fourth reflecting element of the imaging device, wherein the third reflecting element and the fourth reflecting element are each mounted to a particular internal surface of the imaging device;
wherein rays reflected by the second reflecting element and the fourth reflecting element each impinge upon an image sensor of the imaging device for three-dimensional (3D) image reconstruction of the source or object, and wherein the optical path length between the first lensing element and the image sensor is equal to the optical path length between the second lensing element and the image sensor.

2. The imaging device of claim 1, wherein a length of the optical path between the first lensing element and the first reflecting element is different than a length of the optical path between the first reflecting element and the second reflecting element.

3. The imaging device of claim 2, wherein the length of the optical path between the first lensing element and the first reflecting element is greater than the length of the optical path between the first reflecting element and the second reflecting element.

4. The imaging device of claim 2, wherein the length of the optical path between the first lensing element and the first reflecting element is less than the length of the optical path between the first reflecting element and the second reflecting element.

5. The imaging device of claim 1, wherein the image sensor is a first image sensor and the imaging device further comprises:
a third and fourth lensing element to collect and focus rays emanating from the source or object, wherein the third and fourth lensing element are each mounted to a surface of the imaging device and are separated by a particular length or distance along an external surface of the imaging device;
a fifth reflecting element to collect and redirect rays from the third lensing element to a sixth reflecting element of the imaging device, wherein the fifth reflecting element and the sixth reflecting element are each mounted to a particular internal surface of the imaging device; and
a seventh reflecting element to collect and redirect rays from the fourth lensing element to an eighth reflecting element of the imaging device, wherein the seventh reflecting element and the eighth reflecting element are each mounted to a particular internal surface of the imaging device;
wherein rays reflected by the sixth reflecting element and the eighth reflecting element each impinge upon the second image sensor of the imaging device for 3D image reconstruction of the source or object.

6. The imaging device of claim 5, wherein a distance between the first and second lensing element is equal to a distance between the third and fourth lensing element.

7. The imaging device of claim 5, wherein the reconstruction of the source object comprises reconstructing the source object based at least in part on a combination of the impinging upon the first image sensor and the impinging upon the second image sensor.

8. The imaging device of claim 1, wherein the imaging device is built into a mobile device and is used for an application-based computer vision (CV) operation.

9. A method for reconstructing a three-dimensional (3D) image, comprising:
collecting, via a first and second lensing element, rays emanating from a source or object, wherein the first and second lensing element are each mounted to a surface of an imaging device and are separated by a particular length or distance along an external surface of the imaging device;
focusing, via the first lensing element, the rays emanating from the source or object towards a first reflecting element;
focusing, via the second lensing element, the rays emanating from the source or object towards a second reflecting element;
redirecting, via the first reflecting element, the focused rays from the first lensing element toward a second reflecting element, wherein the first reflecting element and the second reflecting element are each mounted to a particular internal surface of the imaging device, and wherein the rays impinge, via the second reflecting element, upon an image sensor of the imaging device;
redirecting, via a third reflecting element, the focused rays from the second lensing element toward a fourth reflecting element, wherein the third reflecting element and the fourth reflecting element are each mounted to a particular internal surface of the imaging device, and wherein the redirected rays impinge, via the fourth reflecting element, upon the image sensor of the imaging device; and
reconstructing a 3D image representing the source or object based at least in part on the rays impinged, via the second reflecting element and the fourth reflecting element, upon the image sensor of the imaging device.

10. The method of claim 9, wherein a length of the optical path between the first lensing element and the first reflecting element is different than a length of the optical path between the first reflecting element and the second reflecting element.

11. The method of claim 10, wherein the length of the optical path between the first lensing element and the first reflecting element is greater than the length of the optical path between the first reflecting element and the second reflecting element.

12. The method of claim 10, wherein the length of the optical path between the first lensing element and the first reflecting element is less than the length of the optical path between the first reflecting element and the second reflecting element.

13. The method of claim 9, wherein the image sensor is a first image sensor and the method further comprises:
collecting, via a third and fourth lensing element, rays emanating from a source or object, wherein the third and fourth lensing element are each mounted to a surface of an imaging device and are separated by a particular length or distance along an external surface of the imaging device;
focusing, via the third lensing element, the rays emanating from the source or object towards a fifth reflecting element;
focusing, via the fourth lensing element, the rays emanating from the source or object towards a sixth reflecting element;
redirecting, via the fifth reflecting element, the focused rays from the third lensing element toward a sixth reflecting element, wherein the fifth reflecting element and the sixth reflecting element are each mounted to a particular internal surface of the imaging device, and wherein the rays impinge, via the sixth reflecting element, upon the second image sensor of the imaging device;
redirecting, via a seventh reflecting element, the focused rays from the fourth lensing element toward an eighth reflecting element, wherein the seventh reflecting element and the eighth reflecting element are each mounted to a particular internal surface of the imaging device, and wherein the redirected rays impinge, via the eighth reflecting element, upon the second image sensor of the imaging device; and
reconstructing the three-dimensional (3D) image representing the source or object based at least in part on the rays impinged, via the second reflecting element and the fourth reflecting element, upon the first image sensor of the imaging device, and at least in part on the rays impinged, via the sixth reflecting element and the eighth reflecting element, upon the second image sensor of the imaging device.

14. The method of claim 13, wherein a distance between the first and second lensing element is equal to a distance between the third and fourth lensing element.

15. The method of claim 13, wherein the reconstruction of the source object comprises reconstructing the source object based at least in part on a combination of the impinging upon the first image sensor and the impinging upon the second image sensor.

16. The method of claim 9, wherein the imaging device is built into a mobile device and is used for an application-based computer vision (CV) operation.

17. An apparatus for reconstructing a three-dimensional (3D) image, comprising:
means for collecting, via a first and second lensing element, rays emanating from a source or object, wherein the first and second lensing element are each mounted to a surface of an imaging device and are separated by a particular length or distance along an external surface of the imaging device;
means for focusing, via the first lensing element, the rays emanating from the source or object towards a first reflecting element;
means for focusing, via the second lensing element, the rays emanating from the source or object towards a second reflecting element;
means for redirecting, via the first reflecting element, the focused rays from the first lensing element toward a second reflecting element, wherein the first reflecting element and the second reflecting element are each mounted to a particular internal surface of the imaging device, and wherein the rays impinge, via the second reflecting element, upon an image sensor of the imaging device;
means for redirecting, via a third reflecting element, the focused rays from the second lensing element toward a fourth reflecting element, wherein the third reflecting element and the fourth reflecting element are each mounted to a particular internal surface of the imaging device, and wherein the redirected rays impinge, via the fourth reflecting element, upon the image sensor of the imaging device; and
means for reconstructing the 3D image representing the source or object based at least in part on the rays impinged, via the second reflecting element and the fourth reflecting element, upon the image sensor of the imaging device.

18. The apparatus of claim 17, wherein a length of the optical path between the first lensing element and the first reflecting element is different than a length of the optical path between the first reflecting element and the second reflecting element.

19. The apparatus of claim 18, wherein the length of the optical path between the first lensing element and the first reflecting element is greater than the length of the optical path between the first reflecting element and the second reflecting element.

20. The apparatus of claim 18, wherein the length of the optical path between the first lensing element and the first reflecting element is less than the length of the optical path between the first reflecting element and the second reflecting element.

21. The apparatus of claim 17, wherein the image sensor is a first image sensor and the apparatus further comprises:
means for collecting, via a third and fourth lensing element, rays emanating from a source or object, wherein the third and fourth lensing element are each mounted to a surface of an imaging device and are separated by a particular length or distance along an external surface of the imaging device;
means for focusing, via the third lensing element, the rays emanating from the source or object towards a fifth reflecting element;
means for focusing, via the fourth lensing element, the rays emanating from the source or object towards a sixth reflecting element;
means for redirecting, via the fifth reflecting element, the focused rays from the third lensing element toward a sixth reflecting element, wherein the fifth reflecting element and the sixth reflecting element are each mounted to a particular internal surface of the imaging device, and wherein the rays impinge, via the sixth reflecting element, upon the second image sensor of the imaging device;
means for redirecting, via a seventh reflecting element, the focused rays from the fourth lensing element toward an eighth reflecting element, wherein the seventh reflecting element and the eighth reflecting element are each mounted to a particular internal surface of the imaging device, and wherein the redirected rays impinge, via the eighth reflecting element, upon the second image sensor of the imaging device; and
means for reconstructing the three-dimensional (3D) image representing the source or object based at least in part on the rays impinged, via the second reflecting element and the fourth reflecting element, upon the first image sensor of the imaging device, and at least in part on the rays impinged, via the sixth reflecting element and the eighth reflecting element, upon the second image sensor of the imaging device.

22. The apparatus of claim 21, wherein a distance between the first and second lensing element is equal to a distance between the third and fourth lensing element.

23. The apparatus of claim 21, wherein the reconstruction of the source object comprises reconstructing the source object based at least in part on a combination of the impinging upon the first image sensor and the impinging upon the second image sensor.

24. One or more non-transitory computer-readable media storing computer-executable instructions for reconstructing a three-dimensional (3D) image that, when executed, cause one or more computing devices to:
collect, via a first and second lensing element, rays emanating from a source or object, wherein the first and second lensing element are each mounted to a surface of an imaging device and are separated by a particular length or distance along an external surface of the imaging device;
focus, via the first lensing element, the rays emanating from the source or object towards a first reflecting element;
focus, via the second lensing element, the rays emanating from the source or object towards a second reflecting element;
redirect, via the first reflecting element, the focused rays from the first lensing element toward a second reflecting element, wherein the first reflecting element and the second reflecting element are each mounted to a particular internal surface of the imaging device, and wherein the rays impinge, via the second reflecting element, upon an image sensor of the imaging device;
redirect, via a third reflecting element, the focused rays from the second lensing element toward a fourth reflecting element, wherein the third reflecting element and the fourth reflecting element are each mounted to a particular internal surface of the imaging device, and wherein the redirected rays impinge, via the fourth reflecting element, upon the image sensor of the imaging device; and
reconstruct the 3D image representing the source or object based at least in part on the rays impinged, via the second reflecting element and the fourth reflecting element, upon the image sensor of the imaging device.

25. The non-transitory computer readable media of claim 24, wherein a length of the optical path between the first lensing element and the first reflecting element is different than a length of the optical path between the first reflecting element and the second reflecting element.

26. The non-transitory computer readable media of claim 25, the length of the optical path between the first lensing element and the first reflecting element is greater than the length of the optical path between the first reflecting element and the second reflecting element.

27. The non-transitory computer readable media of claim 25, wherein the length of the optical path between the first lensing element and the first reflecting element is less than the length of the optical path between the first reflecting element and the second reflecting element.

28. The non-transitory computer readable media of claim 24, wherein the image sensor is a first image sensor and the method further comprises:
collecting, via a third and fourth lensing element, rays emanating from a source or object, wherein the third and fourth lensing element are each mounted to a surface of an imaging device and are separated by a particular length or distance along an external surface of the imaging device;
focusing, via the third lensing element, the rays emanating from the source or object towards a fifth reflecting element;
focusing, via the fourth lensing element, the rays emanating from the source or object towards a sixth reflecting element;
redirecting, via the fifth reflecting element, the focused rays from the third lensing element toward a sixth reflecting element, wherein the fifth reflecting element and the sixth reflecting element are each mounted to a particular internal surface of the imaging device, and wherein the rays impinge, via the sixth reflecting element, upon the second image sensor of the imaging device;
redirecting, via a seventh reflecting element, the focused rays from the fourth lensing element toward an eighth reflecting element, wherein the seventh reflecting element and the eighth reflecting element are each mounted to a particular internal surface of the imaging device, and wherein the redirected rays impinge, via the eighth reflecting element, upon the second image sensor of the imaging device; and
reconstructing the three-dimensional (3D) image representing the source or object based at least in part on the rays impinged, via the second reflecting element and the fourth reflecting element, upon the first image sensor of the imaging device, and at least in part on the rays impinged, via the sixth reflecting element and the eighth reflecting element, upon the second image sensor of the imaging device.

29. The non-transitory computer readable media of claim 28, wherein a distance between the first and second lensing element is equal to a distance between the third and fourth lensing element.

30. The non-transitory computer readable media of claim 28, wherein the reconstruction of the source object comprises reconstructing the source object based at least in part on a combination of the impinging upon the first image sensor and the impinging upon the second image sensor.
